(19) United States
(12) Patent Application Publication
(10) Pub. No.: US 2026/0335975 A1
(43) Pub. Date: Oct. 29, 2026

(54) NANOPARTICLE COMPOSITE

(71) Applicant: SHOEI CHEMICAL INC., Tokyo (JP)

(72) Inventor: Naoto Shindo, Tokyo (JP)

(21) Appl. No.: 19/109,961

(22) PCT Filed: Sep. 7, 2023
(86) PCT No.: PCT/JP2023/032736

§ 371 Date: Mar. 7, 2025

(30) Foreign Application Priority Data
Sep. 9, 2022 (JP) 2022-144107
Sep. 9, 2022 (JP) 2022-144110

(51) Int. Cl. B22F 1/12; B22F 1/054

(52) U.S. Cl. CPC B22F 1/12; B22F 1/054; B22F 2304/054

(57) ABSTRACT

A nanoparticle composite in accordance with one embodiment of the present invention comprises a nanoparticle (11), a ligand (12) bound to said nanoparticle, and a functional particle (13) bound to the nanoparticle via said ligand, and has a structure in which said nanoparticle is surrounded by said functional particles. In the nanoparticle composite in accordance with one embodiment of the present invention, the nanoparticle is contained in an aggregate structure (14) composed of a plurality of functional particles, and said nanoparticle and said aggregate structure are bound via the ligand.

### TECHNICAL FIELD

This invention relates to a nanoparticle composite.

The present application claims the benefit of priority from Japanese Patent Application Serial No. 2022-144107 and Japanese Patent Application Serial No. 2022-144110, filed on Sep. 9, 2022, and the entire content of which is incorporated herein by reference.

### BACKGROUND ART

In general, nanoparticles have a large specific surface area, which makes them prone to surface oxidation and aggregation, depending on the composition of the nanoparticles. Among nanoparticles, quantum dots (QDs), in particular, have a high surface activity and easily react with moisture and oxygen in the atmosphere, resulting in degradation. To solve these problems, many researches have been done for protection of quantum dot surfaces.

For example, in Patent Document 1, a method for producing a quantum dot (QD) material is disclosed, in which the method comprises: mixing a core-forming metal complex with a pnictogen compound to form a nanocrystalline core material, adding a modifier containing chlorine and/or bromine to a solution containing the nanocrystalline core material, modifier treating a surface of the nanocrystalline core material with a modifier to form a modifier-treated nanocrystalline core, mixing an outer shell-forming metal complex and a chalcogen compound with a solution containing the modifier-treated nanocrystalline core material to form an outer shell on each modified nanocrystalline core material, and modifier treating a surface of the outer shell with the modifier added to the solution containing the nanocrystalline core material.

Patent Document 2 discloses quantum dots with improved stability by modifying the surface of the semiconductor crystal particle with a ligand having two or more functional groups for interaction with the semiconductor crystal particle coordinating through two or more sites on a surface of the semiconductor crystal particle.

Patent Document 3 discloses hydrophobizing quantum dots coated with SiO₂ to provide hydrophobic semiconductor particles that are easily dispersed in organic solvents and resins.

In the Patent Document 4, an inorganic nanophosphor particle composite is disclosed, characterized in that it comprises an inorganic nanophosphor particle and an inorganic fine particle deposited on a surface of the inorganic nanophosphor particle.

Quantum dots processed in this way are expected to be used as wavelength conversion materials for displays, biomarker materials for medical applications, and solar cell materials.

### CITATION LIST

### Patent Literature

[Patent Document 1] WO2017/188300
[Patent Document 2] JP-A-2019-099694
[Patent Document 3] JP-A-2021-182025
[Patent Document 4] JP-A-2018-080272

### Non-Patent Literature

[Non-patent literature 1] Murray et. al J. Am. Chem. Soc. 1993, 115, 8706-8715

### SUMMARY OF INVENTION

### Technical Problem

As mentioned above, many researches have been done to form the nanoparticle composite for protecting the surface of nanoparticles by applying a surface treatment to the nanoparticle surface using materials different from the nanoparticle.

However, in the surface treatment of nanoparticles with ligands as described in Patent Document 2, the ligands tend to be desorbed from the nanoparticle surface by thermal vibration when the nanoparticle composite is heated because the ligands are not resistant to heat. The areas where the ligands are desorbed become points of attack for moisture and oxygen, and this becomes a contributing factor for deterioration of the nanoparticle characteristics. On the other hand, the surface treatment of nanoparticles with oxides, as described in Patent Document 3, often covers the nanoparticles with a dense oxide film, which is also called a protective film or a protective layer. Although by covering the nanoparticle surface with a dense oxide film, the nanoparticle surface can indeed be protected, unlike micro-order particles, it is very difficult to form a thin, uniform coating film on nanoparticles, and the non-uniform coverage can become a point of attack for moisture and oxygen, which can lead to deterioration of the nanoparticle characteristics. When the nanoparticle composite is applied to an application, the oxide film may peel off when the nanoparticle composite is stressed, and the peeled off areas may become points of attack for moisture and oxygen, which can lead to deterioration of the nanoparticle characteristics.

Some processing methods also require heating processes when forming oxide layers or oxide films. In this case, the nanoparticles themselves are also heated during the formation of the oxide layers or oxide films, which can cause thermal damage to the nanoparticles and can lead to deterioration of the nanoparticle characteristics.

Therefore, the purpose of the present invention is to provide a nanoparticle composite in which a ligand is bound to the surface of the nanoparticle and said ligand is difficult to be desorbed.

### Solution to Problem

The nanoparticle composite of the present invention is a nanoparticle composite, comprising a nanoparticle, a ligand bound to said nanoparticle, and a functional particle bound to the nanoparticle via said ligand, and having a structure in which said nanoparticle is surrounded by said functional particles. It is also a nanoparticle composite in which the nanoparticle is contained in an aggregate structure composed of a plurality of functional particles, and said nanoparticle and said aggregate structure are bound via the ligand.

### Advantageous Effects of Invention

According to the present invention, it is possible to provide nanoparticle composites in which a ligand is bound to the surface of the nanoparticle and said ligand is difficult to be desorbed.

### DESCRIPTION OF DRAWINGS

FIG. 1 shows a schematic representation of an example of the morphology of a nanoparticle composite in accordance with one embodiment of the present invention.

FIG. 2 shows a schematic representation of an example of the morphology of a nanoparticle composite in accordance with one embodiment of the present invention.

FIG. 3 is a transmission electron microscope (TEM) image of the nanoparticle composite prepared in Experiment 1.

FIG. 4 shows the results showing the mass reduction for the thermogravimetric analysis of the nanoparticle composites prepared in Experiments 1 and 9, and the functional particles alone.

FIG. 5A is a graph representing the results of differential thermal analysis of the nanoparticle composite prepared in Experiment 9.

FIG. 5B is a graph representing the results of differential thermal analysis of the nanoparticle composite prepared in Experiment 1.

FIG. 5C is a graph representing the results of differential thermal analysis of the nanoparticle composite prepared in Experiment 10.

FIG. 5D is a graph representing the results of differential thermal analysis of the nanoparticle composite prepared in Experiment 11.

FIG. 5E is a graph representing the results of differential thermal analysis of the nanoparticle composite prepared in Experiment 12.

### DESCRIPTION OF EMBODIMENTS

The nanoparticle composite in accordance with the present invention comprises a nanoparticle, a ligand bound to said nanoparticle, and a functional particle bound to the nanoparticle via said ligand, and has a structure in which said nanoparticle is surrounded by a plurality of said functional particles. The nanoparticle is contained in an aggregate structure composed of a plurality of functional particles, and said nanoparticle and said aggregate structure are bound via the ligand. In the present invention, the ligand has a binding group with the nanoparticle and a binding group with the functional particle at yet another site, and said ligand is bound to the surface of the nanoparticle via the nanoparticle binding group and also bound to the functional particle via the functional particle binding group.

The nanoparticle composite of the present invention improves weather resistance compared to those in which the surface of the nanoparticle is treated by the ligand only, as described in Patent Document 2, and suppresses the occurrence of points of attack and provides practical weather resistance compared to those in Patent Document 3.

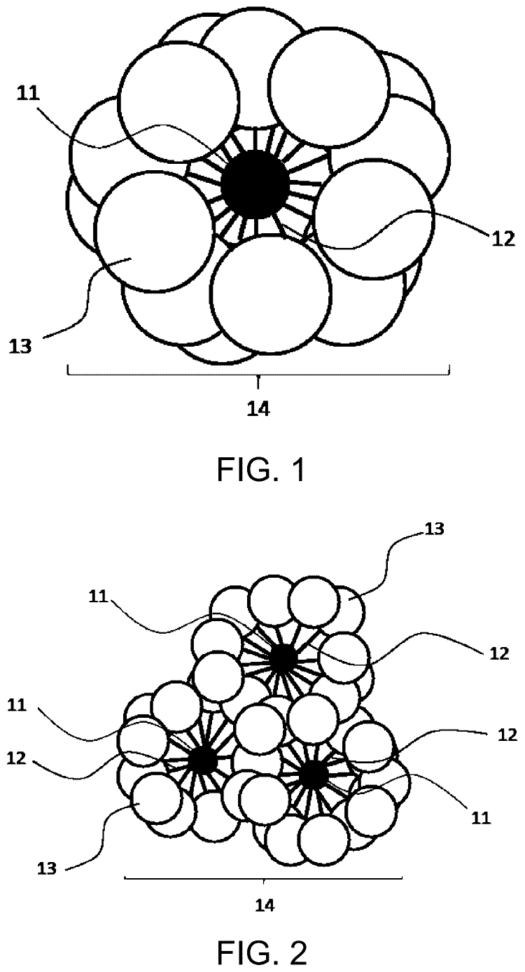

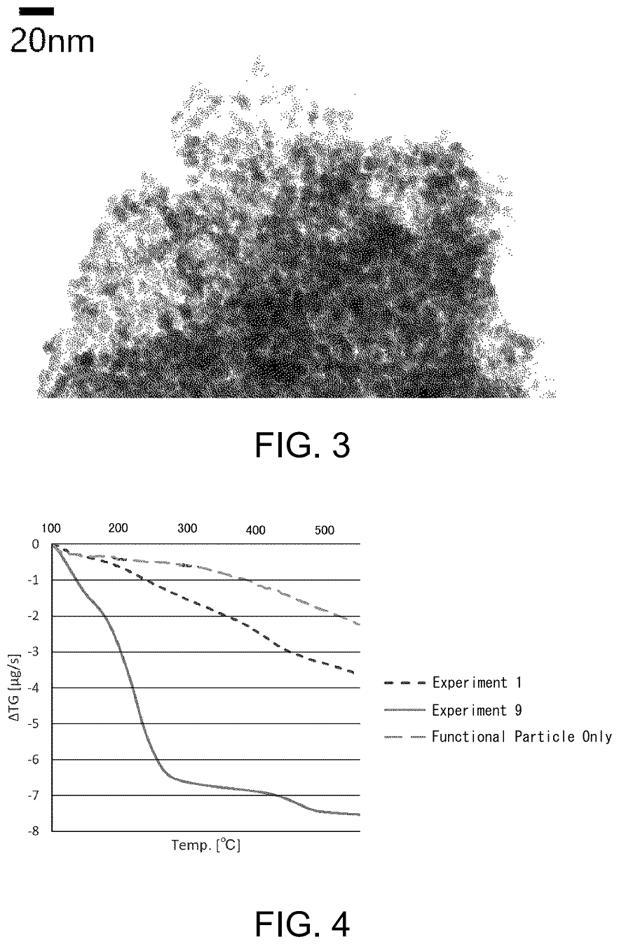

FIGS. 1 and 2 show an example of an embodiment of a nanoparticle composite. The nanoparticle composite is composed of a nanoparticle 11, a ligand 12, and a functional particle 13. The nanoparticle composite has a structure in which the nanoparticle 11 is surrounded by a plurality of functional particles 13, as shown in FIG. 1. The nanoparticle 11 is contained in an aggregate structure 14 composed of a plurality of functional particles 13, and the nanoparticle 11 and the aggregate structure 14 are bound together via the ligand 12. The nanoparticle composite in accordance with the present invention may also have a structure as shown in FIG. 2. The nanoparticle 11 contained in the aggregate structure 14 need not be one, but multiple nanoparticles may be possible. The functional particle 13 may be bound to the plurality of nanoparticle 11 via the ligand 12.

The structure of the nanoparticle composite shown in FIG. 1 or FIG. 2 is only an example, and does not mean that the nanoparticle composite disclosed in this application is limited to the structure shown in FIG. 1 or FIG. 2.

The following is a description of the preferred embodiment.

### <Nanoparticle>

The nanoparticles that make up the nanoparticle composite in this invention include metallic nanoparticles and semiconductor nanoparticles (quantum dots). Metal nanoparticles are not particularly limited, but include particles with a particle diameter of 1 nm to 100 nm made of metals such as Ni and Ag and alloys. Among nanoparticles, quantum dots are particularly susceptible to degradation due to external factors, so the effects of the present invention can be obtained when the nanoparticles are quantum dots. In the present invention, quantum dots are nanoparticles of semiconductor crystals on the nanoscale of 1 nm to 100 nm with unique optical properties that follow quantum mechanics. For quantum dots, those having the properties described in Non-Patent Document 1, as well as those consisting of group II-VI elements, etc., group III-V elements, etc., group IV elements, etc., or group IV-VI elements, etc. are used, but quantum dots are not limited to these.

The particle diameter of a nanoparticle can be measured, for example, by calculating the area circular equivalent diameter (Heywood diameter) of 10 or more particles in a particle image observed with a transmission electron microscope (TEM).

### <Ligand>

In the present invention, the ligand has a nanoparticle binding group and also a functional particle binding group. These binding groups may be arranged at a main chain end or at a side chain end of the ligand. The ligand may be linear or branched. Preferably, the ligand is linear and has each binding group at each end of the linear chain, and it is even more preferred to have each binding group at each end of the linear chain. This is because having a binding group at the end, especially at the terminal, of the linear chain increases the range of motion of the functional particle, which will be described later. It is preferable to have one or more functional particle binding groups for one ligand, but the number is not limited and may be multiple. The ratio of the number of ligands to the number of functional particles can be from 1000:1 to 1:200, for example, without requiring a one-to-one correspondence between each one of ligands and each functional particle bound to each of them. The ratio of the number of ligands to the number of functional particles is preferably 1000:1 to 1:100, more preferably 500:1 to 1:50, even more preferably 300:1 to 1:30, and most preferably 100:1 to 1:10, whereby the functional particles hold down the ligands, thereby ligand desorption due to thermal vibration can be suppressed.

When the ratio of the number of ligands to functional particles is close to 1:1, it means specifically 500:1 to 1:50, preferably 300:1 to 1:30, and more preferably 100:1 to 1:10. When the ratio of the number of ligands to the number of functional particles is close to 1:1, it is preferred because the functional particles can be flexibly movable.

In the present invention, a nanoparticle binding group is a functional group that binds to the nanoparticles. The type of bonding can be either chemical or physical, specifically including coordination bonding, covalent bonding, hydrogen bonding, hydrophobic interaction, and physical adsorption, but a functional group that forms strong bonds with the nanoparticle surface is preferred. Nanoparticle binding groups include, for example, thiol groups (—SH), or amino groups (—NH₂), carboxyl groups (—COOH), phosphate groups, sulfone groups, imine groups, imide groups, amide groups, and cyanate. Depending on the composition of the nanoparticle surface, thiol groups (—SH) or amino groups (—NH₂) are particularly preferred because they can bond strongly to the nanoparticle surface.

On the other hand, in the present invention, a functional particle binding group is a functional group that binds to the functional particles. The type of bonding can be either chemical or physical, specifically including coordination bonding, covalent bonding, hydrogen bonding, hydrophobic interaction, and physical adsorption, but a functional group that forms strong bonds (e.g., bonds by dehydration condensation) with the functional particles is especially preferred. Depending on the surface state of the functional particles, it is preferred that the functional particle binding group contains a carboxyl group (—COOH) or a hydroxyl group (—OH). This is because the functional particle binding group containing a carboxyl group (—COOH) or hydroxyl group (—OH) allows the ligand to bind more strongly to the functional particle. Although the mechanism is not clear, the inventors have found that stronger binding of the ligand to the functional particles can better suppress the desorption of the ligand from the nanoparticles.

The ligand preferably has a small molecular weight. The smaller molecular weight of the ligand allows the physical distance between the nanoparticle and the functional particle to be closer and the volume of the nanoparticle composite to be smaller. Specifically, the molecular weight of the ligand is preferably less than 250. By keeping the volume of the nanoparticle composite small, it is possible to increase the content rate of the nanoparticle composite in the dispersion solution containing the nanoparticle composite and the film, etc., described below. The small molecular weight of the ligand also makes the distance between the nanoparticle and the functional particle physically closer, allowing the agglomerated structure composed of the functional particles to form a dense structure and surround the nanoparticles, depending on the particle size of the functional particles. Details will be described later, but even if they form a dense structure as an agglomerated structure, basically neighboring functional particles are not strongly bonded to each other. Therefore, when external stress is applied to the nanoparticle composite, the functional particles can move flexibly, and the stress can be mitigated. This leads to suppression of ligand desorption from the nanoparticle.

From the above, particularly preferred forms of ligands are ligands that contain nanoparticle binding groups comprising thiol groups and contain carboxyl or hydroxyl groups as functional particle binding groups, and have small molecular weight. Specifically, the examples thereof include mercaptopropionic acid and thioglycolic acid. By using mercaptopropionic acid, thiolactic acid, and thioglycolic acid, the desorption of the ligand from the nanoparticle can be suppressed, and furthermore, the content rate of the nanoparticle composite in the dispersion solution containing the nanoparticle composite described below, films, and the like can be increased.

In the Patent Document 2, a chelating ligand that coordinates to the nanoparticles through two or more sites is used as a ligand to enhance the stability of the nanoparticles. Conventionally, it has been thought that multidentate coordination of the nanoparticle surface is more effective than monodentate coordination in suppressing ligand desorption from the nanoparticle surface. However, when a functional particle is bound to the ligand as in the present invention, even if the ligand is coordinated through a single site, the functional particle can suppress desorption of the ligand, thus, the ligand does not necessarily need to coordinate to the nanoparticle through multiple sites. In other words, the ligand in accordance with the present invention can be monodentate or multidentate. In the case of monodentate, the advantage is that the range of motion of the functional particles is expanded.

### <Functional Particle>

The functional particles are bound to a nanoparticle via ligands and have a structure surrounding the nanoparticle. Functional particles bind to the ligand via functional particle binding groups.

For one nanoparticle, the functional particles form an aggregate structure with multiple functional particles arranged around the nanoparticle via the ligand.

The particle diameter of the functional particle is preferably 1 nm to 100 nm. If the functional particles are 1 nm to 100 nm in diameter, they can effectively surround the nanoparticles. The particle diameter of the functional particle is the average particle diameter (BET diameter) converted from the measured BET specific surface area using a true sphere model.

The number of functional particles forming an agglomerated structure, depending on particle size of nanoparticles and functional particles, is preferably from 1 to 800 particles per nanoparticle, more preferably 2 to 600 particles, and even more preferably 4 to 500 particles. The agglomerated structure composed of functional particles can effectively contain nanoparticles when the number of functional particles is from 4 to 800 for one nanoparticle.

The functional particles can be inorganic or organic. By selecting appropriate functional particles, various properties can be imparted to the nanoparticle composite. The substance selected as the functional particle may be only one type or a combination of several types.

For example, if a substance with a high reflectance or refractive index is used as a functional particle, the nanoparticle composite is expected to have a role as a scattering agent when applied to films, etc. as described later. For example, functional particles with a high refractive index include titania particles (TiO₂), zinc oxide particles (ZnO), zirconia (ZrO₂), etc.

It is preferred that the functional particles have hydroxyl groups on their surfaces. The hydroxyl groups on the surface of the functional particles react with the functional particle binding groups of the ligand and suppress desorption of the ligand from the nanoparticle. At this time, the ligand and the functional particle should be bound by dehydration condensation, which has a strong binding force.

Furthermore, the functional particles may have an organic group that reacts with the ligand. By having an organic group on the surface of the functional particles, it is possible to select organic solvents for the dispersion solution of the functional particles, which allows for a wider range of choices as the functional particles.

The organic group that reacts with the ligand preferably has an epoxy group. Even though the epoxy group is an organic group, it can react with the functional particle binding group of the ligand, thereby preventing the ligand from desorbing from the nanoparticle.

Also, the nanoparticle composite can be given weather resistance by selecting an appropriate substance as the functional particle. It is thought that the functional particles bind to the ligand coordinated to the surface of the nanoparticle, and the desorption of the ligand can be suppressed by the functional particles holding the ligand down, thereby improving the weather resistance of the nanoparticle composite. In this case, it can be preferred that inorganic particles with high density are selected as the functional particles because they are more effective in holding down the ligand.

In the present invention, the inventor found that the weather resistance of the nanoparticle composite is improved when the functional particles are silica particles (SiO₂) or particles containing Si. Although the mechanism is unknown, it is thought to be due to the effect of indirect suppression of ligand desorption from the nanoparticle surface by strong binding of the functional particles to the functional particle binding group of the ligand.

In particular, if the functional particles are silica particles or Si-containing particles, the hydroxyl groups on the surface may be part of the silanol groups. Although the mechanism is not clear, when the functional particles have silanol groups on their surface, the nanoparticle composite has particularly high weather resistance because a stronger bond with the functional particle binding group of the ligand is formed. Si-containing particles include, for example, zirconium silicate and aluminum silicate.

When improving weather resistance, particles other than silica particles may be mixed as the functional particles. For example, afore-mentioned silica particles and titania particles may be mixed in a ratio according to the purpose or application to form an aggregate structure to contain nanoparticles. In this case, as the ratio of silica particles to functional particles other than silica particles, the weather resistance of the nanoparticle composite is improved by making silica particles account for 10 vol. % or more, preferably 30 vol. % or more, more preferably 50 vol. % or more, and even more preferably 70 vol. % or more of the total functional particles by volume.

Other possible methods to improve the binding force between the functional particles and the ligand include covering the surface of the functional particles with any substance.

In the patent Document 4, inorganic particles are directly attached to the surface of inorganic nanophosphor particles, but this process is done to finally disperse the inorganic nanophosphor particles (nanoparticles) in the glass matrix. In a state consisting only of inorganic nanophosphor particles and inorganic microparticles, the inorganic microparticles and inorganic nanophosphor particles are only physically adsorbed, so the inorganic microparticles are easily detached from the nanoparticle surface. In the Patent Document 4, a glass matrix is essential because the inorganic particles would easily detach from the surface of the nanoparticles without the presence of the glass matrix, especially when external stress or thermal vibration is applied, because they do not have a ligand that firmly connects the nanoparticles and the inorganic particles. On the other hand, the glass matrix can be present or absent in the nanoparticle composite of the present invention. The advantage of the absence of a glass matrix is that it can be manufactured in a simplified manner.

In the present invention, the functional particles protect the surface of the nanoparticle via the ligand, thus the functional particles are more flexible and movable than when the surface of the nanoparticle is directly coated with functional particles without the ligand. Therefore, when external stress is applied to the nanoparticle composite, the functional particles can relax the stress by moving flexibly while the functional particles keep protecting the nanoparticle, thereby suppressing the desorption of the ligand from the nanoparticle surface. Even if one of the functional particles is desorbed, not only is the protection of the nanoparticle by the ligand maintained, but also the functional particles adjacent to the detached functional particle move flexibly and cover the area where the functional particle was desorbed, since the adjacent functional particles are basically not strongly bound to each other. Thus, fatal property degradation of the nanoparticle can be avoided, and practical weather resistance as nanoparticle composites can be maintained.

### <Composite>

The nanoparticle composite of the present invention has a configuration in which a nanoparticle is contained in an aggregate structure composed of a number of functional particles and ligands, and said functional particles are bound to the nanoparticle via the ligands. By selecting appropriate substances for the functional particles, various functions can be imparted to the nanoparticle composite.

In the Patent Document 1, the surface of the nanoparticles is only modified by a modifier and no treatment to improve dispersibility is performed, so the nanoparticles are likely to aggregate with each other in their original state, which may result in a decrease in luminescence properties. The present invention can also suppress the aggregation of nanoparticles by taking the structure described above, and the decrease in luminescence properties due to the aggregation of nanoparticles can be suppressed.

In the present invention, the nanoparticle composite takes the structure described above to prevent agglomeration because the distance between the nanoparticles increases due to physical contact between the functional particles and other factors.

The nanoparticle composite of the present invention can further improve weather resistance by including silica particles or Si-containing particles in the functional particles and by having the structure described above. In the present invention, improved weather resistance means that the rate of change of fluorescence quantum efficiency by the heat and moisture resistance test described later is 90% or less, preferably 75% or less, more preferably 50% or less, more preferably 25% or less, and most preferably 21.4% or less.

While it has been considered better to cover the entire nanoparticle as a layer or film of the densest possible oxide when protecting nanoparticles with oxides, the present invention is based on the novel finding that nanoparticles can be surrounded by an aggregate structure formed by multiple functional particles via ligands, thereby improving their weather resistance.

In other words, by holding the ligand down with the functional particles, the nanoparticle composite of the present invention not only solves the problem of ligand desorption that the Patent Document 2 has, but has the advantage that heat is less likely to be transferred to the ligand. In addition, unlike the oxide film of Patent Document 3, in the nanoparticle composite of the present invention, even if one of the functional particles is desorbed, not only is the protection of the nanoparticle by the ligand maintained, but also the functional particles adjacent to the detached functional particle move flexibly and cover the area where the functional particle was desorbed, since the adjacent functional particles are basically not strongly bound to each other. Thus, fatal property degradation of the nanoparticle can be avoided.

when stress is applied to the nanoparticle composite, stress relaxation is possible because the functional particles move flexibly, thereby the nanoparticle composite of the present invention also has the advantage of increased process flexibility in handling the nanoparticle composites in applications.

The inventors believe that by changing the fabrication conditions, it is possible to adjust the binding force between the functional particles as needed.

As the nanoparticle composite in accordance with the present invention, the nanoparticle is a quantum dot containing Zn on the surface, and the ligand has a thiol group that can form a Zn—S bond on the nanoparticle surface as the nanoparticle binding group, and the ligand has carboxyl or hydroxyl groups as the functional particle binding group, and the functional particles are silica particles with hydroxyl groups are particularly preferred, although particles other than silica may be mixed. The quantum dots with Zn on the surface include, for example, CdSe/ZnSe with a core-shell structure where the core is CdS and the shell is ZnSe; CdSe/ZnSe with a core-shell structure where the core is CdSe and the shell is ZnSe; CdS/ZnSe/ZnS with a core-shell structure where the core is Cds, the first shell is ZnSe and the second shell is ZnS; CdSe/ZnSe/ZnS with a core-shell structure where the core is CdSe, the first shell is ZnSe and the second shell is ZnS; InP/ZnSe with a core-shell structure where the core is InP and the shell is ZnSe; InP/ZnSe/ZnS with core-shell structure where the core is InP, the first shell is ZnSe and the second shell is ZnS, but not limited to these.

Furthermore, the nanoparticle composite of the present invention also has high acid resistance due to the structure described above. For example, the nanoparticle composite in Experiment 2, described later, showed luminescence even after being immersed in hydrochloric acid at pH 1 for 3 hours. The experimental results under these conditions mean that the nanoparticle composite can be used even being exposed to stomach acid in the human body after being administered orally. Therefore, the nanoparticle composite obtained by the present invention can be applied as a medical marker.

### <Evaluation of Weather Resistance>

The fluorescence quantum efficiency of the nanoparticle composite can be measured using a fluorescence quantum efficiency measurement system (Otsuka Electronics, QE-2100), etc. After the nanoparticle composite is packed in a sample holder, the emission spectrum is obtained by applying excitation light. Optical properties such as fluorescence quantum efficiency (QY), peak wavelength (λmax), and full width at half maximum (FWHM) can be calculated from the emission spectrum after correction for re-excitation, which is the emission spectrum obtained here minus the spectrum for the re-excited fluorescence emission, that is fluorescence emission after re-excited. The excitation light used for the measurement is a single light of 450 nm. In the heat and moisture resistance test described below, the fluorescence quantum efficiency (QY) values measured at room temperature (25 °C) were used to evaluate weather resistance.

The heat and humidity resistance test is conducted by keeping the nanoparticle composite in a constant temperature and humidity chamber at 60 °C and 90% relative humidity for 100 hours. The rate of change in fluorescence quantum efficiency before and after the heat and humidity resistance test is calculated using the fluorescence quantum efficiency before the heat and humidity resistance test (QYa) and the fluorescence quantum efficiency after the heat and humidity resistance test (QYb), using the following formula (1).

Rate of change in fluorescence quantum efficiency={(QYa−QYb)/QYa}×100 (1)

### <Production Method>

The method for producing the nanoparticle composite of the present invention comprises the steps of: in a dispersion solution containing a nanoparticle and a ligand, bonding said nanoparticle and said ligand to obtain a precursor particle dispersion solution; and mixing and reacting said precursor particle dispersion solution with a dispersion solution containing functional particles to obtain a nanoparticle composite dispersion solution in which said functional particles are bound to said nanoparticle via said ligand.

The nanoparticle is the nanoparticle described above, and, for example, metal nanoparticles such as Ni and Ag, semiconductor nanoparticles (quantum dots), and the like can be included for the nanoparticle without any particular limitations.

The ligand is the ligand described above, which has a nanoparticle-binding group and a functional particle-binding group at another site. These binding groups may be arranged at the main chain ends or at the side chain ends. The ligand may be linear or branched. Preferably, the ligand is linear and has each binding group at each end of the linear chain, and it is even more preferred to have each binding group at each end of the linear chain. This is because having a binding group at the end, especially at the terminal, of the linear chain increases the range of motion of the functional particle, which will be described later. It is preferable to have one or more functional particle binding groups for one ligand, but the number is not limited and may be multiple. The ratio of the number of ligands to the number of functional particles can be from 1000:1 to 1:200, for example, without requiring a one-to-one correspondence between each one of ligands and each functional particle bound to each of them. The ratio of the number of ligands to the number of functional particles is preferably 1000:1 to 1:100, more preferably 500:1 to 1:50, even more preferably 300:1 to 1:30, and most preferably 100:1 to 1:10, whereby the functional particles hold down the ligands, thereby ligand desorption due to thermal vibration can be suppressed.

When the ratio of the number of ligands to functional particles is close to 1:1, it means specifically 500:1 to 1:50, preferably 300:1 to 1:30, and more preferably 100:1 to 1:10. When the ratio of the number of ligands to the number of functional particles is close to 1:1, it is preferred because the functional particles can be flexibly movable.

The nanoparticle binding groups are functional groups that bond to nanoparticles. The type of bonding can be either chemical or physical, specifically including coordination bonding, covalent bonding, hydrogen bonding, hydrophobic interaction, and physical adsorption, but a functional group that forms strong bonds with the nanoparticle surface is preferred. Nanoparticle binding groups include, for example, thiol groups (—SH), or amino groups (—NH₂), carboxyl groups (—COOH), phosphate groups, sulfone groups, imine groups, imide groups, amide groups, and cyanate. Depending on the composition of the nanoparticle surface, thiol groups (—SH) or amino groups (—NH₂) are particularly preferred.

On the other hand, the functional particle binding groups are functional groups that bond to functional particles. The type of bonding can be either chemical or physical, specifically including coordination bonding, covalent bonding, hydrogen bonding, hydrophobic interaction, and physical adsorption, but a functional group that forms strong bonds (e.g., bonds by dehydration condensation) with the functional particles is especially preferred. Depending on the surface state of the functional particles, it is preferred that the functional particle binding group contains a carboxyl group (—COOH) or a hydroxyl group (—OH). This is because the functional particle binding group containing a carboxyl group (—COOH) or hydroxyl group (—OH) allows the ligand to bind more strongly to the functional particle. Although the mechanism is not clear, it is thought that the functional particles bond to the ligand coordinated to the surface of the nanoparticle, and the desorption of the ligand can be suppressed by the functional particles holding the ligand down, thereby improving the weather resistance of the nanoparticle composite.

The ligand preferably has a small molecular weight. The smaller molecular weight of the ligand allows the physical distance between the nanoparticle and the functional particle to be closer and the volume of the nanoparticle composite to be smaller. By keeping the volume of the nanoparticle composite small, it is possible to increase the content rate of the nanoparticle composite in the dispersion solution containing the nanoparticle composite and the film, etc., described below. The small molecular weight of the ligand also makes the distance between the nanoparticle and the functional particle physically closer, allowing the agglomerated structure composed of the functional particles to form a dense structure and surround the nanoparticles, depending on the particle size of the functional particles.

From the above, particularly preferred forms of ligands are ligands that contain nanoparticle binding groups comprising thiol groups and carboxyl or hydroxyl groups as functional particle binding groups, and have small molecular weight. Specifically, the examples thereof include mercaptopropionic acid and thioglycolic acid. By using mercaptopropionic acid, thiolactic acid, and thioglycolic acid, the desorption of the ligand from the nanoparticle can be suppressed, and furthermore, the content rate of the nanoparticle composite in the dispersion solution containing the nanoparticle composite described below, films, and the like can be increased.

In the process of obtaining a precursor particle dispersion solution by, in a dispersion solution containing nanoparticles and ligands, bonding said nanoparticles with said ligands, the precursor particle dispersion solution can be obtained by bonding specific ligands with the nanoparticles using known methods (e.g. ligand exchange method) after nanoparticle synthesis. Alternatively, a precursor particle dispersion solution can be obtained by bonding specific ligands with nanoparticles immediately after synthesis by adding specific ligands during nanoparticle synthesis.

The dispersion solution containing the functional particles may be an aqueous dispersion solution containing water as the dispersing medium or an organic solvent-based dispersion solution containing an organic solvent as the dispersing medium. Commercially available dispersion solution containing functional particles may also be used.

The precursor particle dispersion solution is preferably compatible with the dispersion solution of the functional particles. For example, if the dispersion solution containing the functional particles is an aqueous dispersion solution, the precursor particle dispersion solution is also preferably aqueous. If the precursor particle dispersion solution is organic solvent-based, the dispersion liquid containing functional particles should also be organic solvent-based.

In particular, when the functional particles are silica particles or Si-containing particles, it is preferred that both the functional particle dispersion solution and the precursor particle dispersion solution are aqueous. This is because when both the dispersion solution containing the functional particles and the precursor particle dispersion solution are aqueous, hydroxyl groups are present on the surface of the functional particles, and the ligands and functional particles can more easily bind to each other.

The method of mixing the nanoparticle dispersion solution with the dispersion solution containing the functional particles is not particularly limited. Because of the strong binding force of the ligand and functional particles, generally used agitation is sufficient to advance the reaction. The binding force between the ligand and functional particles can be adjusted by appropriately controlling the reaction environment as necessary.

The nanoparticle composite dispersion solution in which the functional particles are bound to said nanoparticle via said ligand is preferably dried. There is no particular limitation as to the method of drying, and heat drying, drying, and freeze drying are preferred. By drying the nanoparticle composite dispersion solution, a nanoparticle composite in which the ligands and the functional particles are more tightly bound can be obtained.

As mentioned above, the method for producing the nanoparticle composite of the present invention comprises the steps of: in a dispersion solution containing nanoparticles and ligands, bonding said nanoparticles and said ligands to obtain a precursor particle dispersion solution; and mixing and reacting said precursor particle dispersion solution with a dispersion solution containing functional particles to obtain a nanoparticle composite dispersion solution in which said functional particles are bound to said nanoparticles via said ligands.

Not limited to this, the method for producing the nanoparticle composite is sufficient if the nanoparticles, the ligands, and the functional particles can react. In particular, mixing the nanoparticles and the functional particles in the state of dispersion solution is preferred because the ligands can bind strongly to the nanoparticles and functional particles. Various methods can be taken as long as the method includes the process of mixing and reacting the dispersion solution containing the functional particles, the ligands, and the dispersion solution containing the nanoparticles.

For example, a method of mixing nanoparticles with a ligand having a nanoparticle binding group that can bind to nanoparticles and a functional particle binding group that can bind to functional particles to obtain nanoparticles to which said ligand is bound, and then mixing said nanoparticles to which said ligand is bound with functional particles may be used. By using this method, the nanoparticles to which said ligand is bound and the functional particles are reacted to obtain a nanoparticle composite in which said functional particles are bound to said nanoparticles via said ligand.

In addition, a method of mixing functional particles with a ligand having a nanoparticle binding group that can bind to nanoparticles and a functional particle binding group that can bind to functional particles to obtain functional particles to which said ligand is bound, and then mixing said functional particles to which said ligand is bound with nanoparticles may be used. By using this method, the functional particles to which said ligand is bound and the nanoparticles are reacted to obtain a nanoparticle composite in which said functional particles are bound to said nanoparticles via said ligand.

From the viewpoint of the functional particles effectively surrounding the nanoparticles and forming an aggregate structure, it is preferable to use the method described above.

### <Dispersion Liquid>.

The nanoparticle composite of the present invention can be made into a dispersion solution containing the nanoparticle composite by dispersing it in any dispersant.

### <Film>

The nanoparticle composite of the present invention can be made into a film containing the nanoparticle composite by dispersing it in any resin or matrix.

### EXAMPLES

### Production Method of QD (CdSe/ZnSe/ZnS)

### <Core Preparation (CdSe)>

First, the Se precursor was prepared by stirring selenium (0.79 g, 10 mmol) and trioctylphosphine (10.9 mL) at 150 °C in an argon gas atmosphere for about 1 hour to completely dissolve selenium. Next, the Cd precursor was prepared by placing cadmium acetate dihydrate (1.97 g, 7.5 mmol) and trioctylphosphine oxide (9.65 g) in a flask and replacing the inside of the flask with an argon gas atmosphere. The Cd precursor was heated to 300 °C, to which 9.9 mL of Se precursor (containing 9 mmol of selenium) was dropped at once and stirred for 5 minutes. After cooling to room temperature, the resulting reactant was purified with butanol and methanol to remove unreacted Cd and Se precursors, trioctylphosphine and excess trioctylphosphine oxide. The purified reactants were diluted with 10 mL of toluene to obtain CdSe nanocrystal solution.

### <Preparation of Shells (CdSe/ZnSe/ZnS)>

First, the S precursor was prepared by stirring sulfur (0.32 g, 10 mmol) and trioctylphosphine (10.9 mL) at 150 °C in an argon gas atmosphere for about 1 hour to completely dissolve sulfur. Eight grams of trioctylamine, 0.1 g of oleic acid, and 0.2 mmol of zinc acetate were placed in a flask and the reaction temperature was adjusted to 300 °C with stirring. After 0.1 mL of the CdSe nanocrystal solution formed in the previous step was added to the reactant, 0.1 mL of the Se precursor was added and allowed to react for about 1 hour. Then 0.1 mL of the S precursor was added and allowed to react for 1 hour.

After the reaction was completed, the temperature of the reaction mixture was lowered to room temperature as quickly as possible, ethanol, a non-reactive solvent, was added, and centrifugation was performed. The supernatant liquid of the solution, excluding the centrifuged sediment, was discarded, and the sediment was dispersed in toluene to form CdSe/ZnSe/ZnS (TEM diameter 15 nm).

The resulting nanoparticles were partially collected, dried, and observed by transmission electron microscopy (TEM). The TEM diameter was determined by calculating the area circular equivalent diameter (Heywood diameter) of 10 or more particles in a particle image observed with a transmission electron microscope (TEM).

### <Preparation of Precursor Particle Dispersion>

Mercaptopropionic acid (MPA: average molecular weight 106) was added to the resulting nanoparticle dispersion solution, and the solution was stirred for 9 hours while heated to 120 °C for ligand exchange. Said solution was then cooled, hexane was added, and centrifuged to separate the agglomerates from the supernatant, after which the supernatant, which is mainly composed of toluene and hexane, was removed. Then, Acetone and hexane were added and washed several times. After removing the acetone and hexane, the nanoparticle dispersion solution in which the nanoparticles were dispersed was prepared by adding water and an appropriate amount of tetramethylammonium hydroxide/methanol solution and stirring.

### <Preparation of Nanoparticle Composites>

### Experiment 1

Colloidal silica dispersion solution (Nissan Chemical: ST-OXS) was used as the dispersion solution containing functional particles.

The precursor particle dispersion solution prepared above and the dispersion solution containing functional particles were collected and mixed in a container. The mixed solution (reaction solution) was then dried in a dryer whose temperature was adjusted to 50 °C to obtain a dried body. The dried product was crushed in a mortar and the resulting nanoparticle composite was measured for quantum efficiency.

The quantum efficiency was measured using a fluorescence quantum efficiency measurement system (Otsuka Electronics, QE-2100). After the nanoparticle composite is packed in a sample holder, the emission spectrum is obtained by applying excitation light (single light at 450 nm). The fluorescence quantum efficiency (QYa) was calculated from the emission spectrum after correction for re-excitation, which is the emission spectrum obtained here minus the spectrum for the re-excited fluorescence emission, that is fluorescence emission after re-excited.

Next, the heat and moisture resistance of the obtained nanoparticle composite was measured. The nanoparticle composite was placed in a constant temperature and humidity chamber (ESPEC: PHP-2J) set at 60 °C and 90% relative humidity, and kept for 100 hours. After 100 hours, the fluorescence quantum efficiency (QYb) was measured again for the nanoparticle composite that was taken out. In the present application, the rate of change of fluorescence quantum efficiency before and after the heat and moisture resistance test is used as an indicator of weather resistance. The rate of change in fluorescence quantum efficiency before and after the heat and humidity resistance test is calculated using the fluorescence quantum efficiency before the heat and humidity resistance test (QYa) and the fluorescence quantum efficiency after the heat and humidity resistance test (QYb), using the following formula (1).

Rate of change in fluorescence quantum efficiency={(QYa−QYb)/QYa}×100 (1)

The rate of change of fluorescence quantum efficiency for the obtained nanoparticle composites is shown in Table 1.

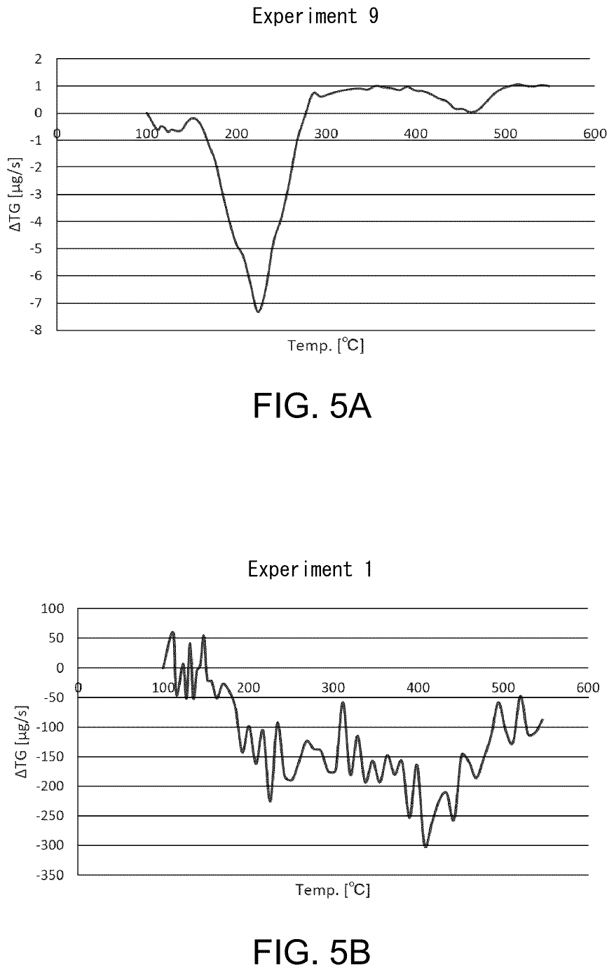

FIG. 3 shows the TEM (transmission electron microscope) images of the nanoparticle composite prepared in Experiment 1. The black particles are the nanoparticles and the gray particles are the functional particles. The nanoparticle composite was observed to be composed of the nanoparticles surrounded by the functional particles.

### Experiment 2

Nanoparticle composites were obtained and characterized in the same way as in Experiment 1, except that colloidal silica dispersion solution (Nissan Chemical: ST-O) was used as the dispersion containing the functional particles.

### Experiment 3

Nanoparticle composites were obtained and characterized in the same way as in Experiment 1, except that colloidal silica dispersion solution (Nissan Chemical: ST-O-40) was used as the dispersion containing the functional particles.

### Experiment 4

Nanoparticle composites were obtained and characterized in the same way as in Experiment 1, except that colloidal silica dispersion solution (Nissan Chemical: ST-OL) was used as the dispersion containing the functional particles.

### Experiment 5

Fumed silica (Aerosil 300 manufactured by NIPPON AEROSIL CO., LTD.) was used as the functional particles, and water was added as a dispersant to prepare a dispersion solution containing functional particles so that the concentration of the functional particles was 4 wt. %. Otherwise, the nanoparticle composites were obtained and characterized in the same manner as in Experiment 1.

### Experiment 6

Fumed silica (Aerosil 200 manufactured by NIPPON AEROSIL CO., LTD.) was used as the functional particles, and water was added as a dispersant to prepare a dispersion solution containing functional particles so that the concentration of the functional particles was 4 wt. %. Otherwise, the nanoparticle composites were obtained and characterized in the same manner as in Experiment 1.

### Experiment 7

Fumed silica (Aerosil 130 manufactured by NIPPON AEROSIL CO., LTD.) was used as the functional particles, and water was added as a dispersant to prepare a dispersion solution containing functional particles so that the concentration of the functional particles was 4 wt. %. Otherwise, the nanoparticle composites were obtained and characterized in the same manner as in Experiment 1.

### Experiment 8

Fumed silica (Aerosil 50 manufactured by NIPPON AEROSIL CO., LTD.) was used as the functional particles, and water was added as a dispersant to prepare a dispersion solution containing functional particles so that the concentration of the functional particles was 4 wt. %. Otherwise, the nanoparticle composites were obtained and characterized in the same manner as in Experiment 1.

### Experiment 9

The fluorescence quantum efficiency measurements were performed with the precursor particle dispersion solution prepared in the same manner as in Experiment 1. For this sample, the fluorescence quantum efficiency in the state of dispersion solution was used as the quantum efficiency before the durability test. The sample was then placed in a constant temperature and humidity chamber in the state of dispersion solution, and the characteristics were evaluated after 100 hours in the same manner.

### Experiment 10

Nanoparticle composites were obtained and characterized in the same way as in Experiment 1, except that a zirconia sol dispersion solution (ZSL00014 from Daiichi Kigenso Kagaku Kogyo Co., Ltd.) was used as the dispersion containing the functional particles.

### Experiment 11

Nanoparticle composites were obtained and characterized in the same way as in Experiment 1, except that alumina sol dispersion liquid (Bailar Al-L7 from Taki Chemical Co., Ltd.) was used as the dispersion liquid containing functional particles.

### Experiment 12

Nanoparticle composites were obtained and characterized in the same way as in Experiment 1, except that titania sol (Tainok AM-15 from Taki Chemical Co., Ltd.) was used as the dispersion containing the functional particles.

### Experiment 13

Fumed alumina (Alu-C manufactured by NIPPON AEROSIL CO., LTD.) was used as functional particles, and water was added as a dispersant to prepare a dispersion solution containing functional particles so that the concentration of the functional particles was 4 wt. %. Otherwise, the nanoparticle composites were obtained and characterized in the same manner as in Experiment 1.

### Experiment 14

Fumed titania (TiO₂ P90 manufactured by AEROSIL JAPAN Ltd.) (Aerosil 130 manufactured by NIPPON AEROSIL CO., LTD.) was used as the functional particles, and water was added as a dispersant to prepare a dispersion solution containing functional particles so that the concentration of the functional particles was 4 wt. %. Otherwise, the nanoparticle composites were obtained and characterized in the same manner as in Experiment 1.

### Experiment 15

Magnesium hydroxide (made by FUJIFILM Corporation) was used as the functional particles, and water was added as a dispersant to prepare a dispersion solution containing functional particles so that the concentration of the functional particles was 4 wt. %. Otherwise, the nanoparticle composites were obtained and characterized in the same manner as in Experiment 1.

### Experiment 16

The core of the nanoparticle in Experiment 1 was changed to InP by the following method.

### <Preparation of Cores (InP)>

Indium acetate (0.3 mmol) was added to a mixture of oleic acid (0.9 mmol) and octadecene (10 mL), heated to about 120 °C under vacuum (<20 Pa), and allowed to react for 1 hour. After placing the mixture reacted in a vacuum under a nitrogen atmosphere at 25 °C and adding tris(trimethylsilyl)phosphine (0.2 mmol), the mixture was heated to about 300 °C and allowed to react for 10 min. The reaction solution was cooled to 25 °C, octanoic acid chloride (0.45 mmol) was injected, heated to about 250 °C for 30 minutes, and then cooled to 25 °C to obtain InP nanocrystal solution.

In addition, silica sol (Nissan Chemical: MEK-EC-2130) with epoxy groups on the surface was used as the functional particles. The other procedures were the same as in Experiment 1, and nanoparticle composites were obtained and characterized.

The particle diameter of the functional particles was determined from the average particle diameter (BET diameter) converted from the measured BET specific surface area using a true sphere model. For those in powder form, the BET specific surface area was measured in powder form, and the average particle diameter (BET diameter) was calculated from the value. For those with functional particles already in dispersion solution, the particles were dried and the BET specific surface area was measured on the dried product, and the average particle diameter (BET diameter) was calculated from that value.

Next, thermogravimetric differential thermal analysis was performed on the resulting nanoparticle composite. Thermogravimetric differential thermal analysis was performed using a Buruker TG-DTA2000SA. A predetermined amount of sample was placed in a sample holder and heated to 550 °C at 10 °C/min while introducing N₂ at 200 mL/min, and thermogravimetric and differential thermal analysis of the nanoparticle composite was performed.

For comparison, thermogravimetric and differential thermal analysis of dried functional particles alone (colloidal silica dispersion (Nissan Chemical: ST-OXS)) was also performed under similar conditions.

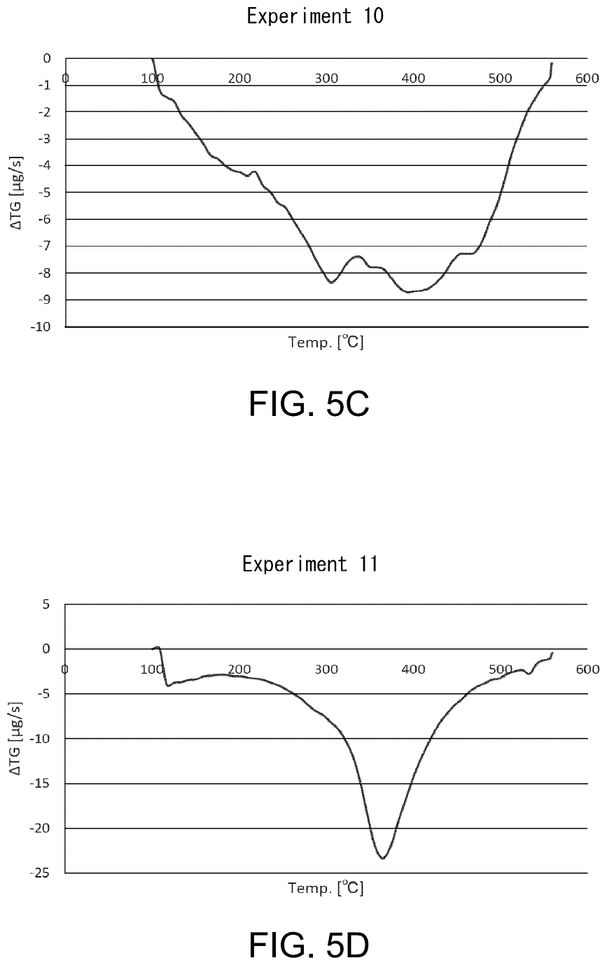

The following figures show the results of mass reduction in thermogravimetric analysis for Experiment 1, Experiment 9, and the aforementioned functional particles alone. FIG. 4 is for overlaid graphs normalized so that the amount of ligand in Experiment 1 is equal to the amount of ligand in Experiment 9, and further normalized so that the amount of functional particles in Experiment 1 is equal to the amount of functional particles alone.

In FIG. 4, a mass reduction of the functional particles themselves can be seen. The inventor believes that this is due to the gradual desorption of water adhering to the functional particles by heating. Based on this, a comparison of the results of Experiment 1 and Experiment 9 shows that all ligands are desorbed by 550 °C in Experiment 9, whereas in Experiment 1, less ligands are desorbed than in Experiment 9. If the mass reduction of the functional particles themselves is taken into account, the amount of ligand desorbed by 550 °C in Experiment 1 is less than 20% of that of the ligand desorbed in Experiment 9.

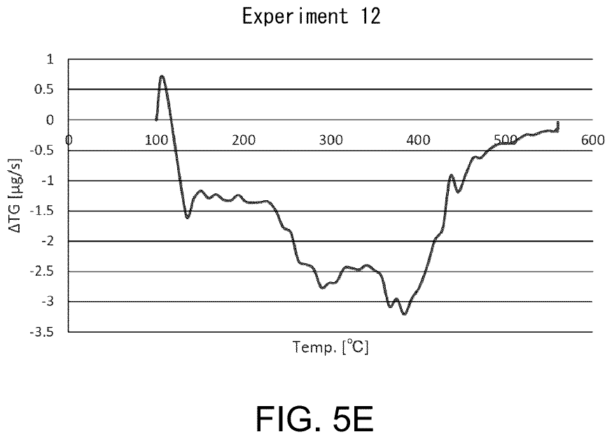

FIGS. 5a through 5e show the results of differential thermal analysis for each nanoparticle composite. ΔTG shows the change in TG per unit time in each temperature range. This ΔTG graph means the temperature at which the ligand is easily desorbed. FIG. 5a shows the graph of ΔTG for Experiment 9, which has a large valley with a peak at 220 °C. This means that a large amount of ligand desorption occurs at around 220 °C for the nanoparticle composite of Experiment 9. On the other hand, FIG. 5B is a graph representing the ΔTG of Experiment 1, and the ΔTG of Experiment 1 has a gradual valley with a peak near 400 °C. This indicates that the ligand is desorbed by the functional particles. This means that ligand desorption is suppressed by the functional particles, and furthermore, if ligand is desorbed, it is desorbed at high temperature. Similarly, FIGS. 5C, 5D, and 5E show the results of differential thermal analysis for Experiments 10, 11, and 12, respectively.

Table 1 shows the peak temperature of the valley of ΔTG of the differential thermal analysis measured in each experiment.

In Experiment 9, the peak temperature of the valley was 220 °C, whereas in the other Experiments, the peak temperature of the valley was seen above 240 °C. This indicates that the structure of the present invention can suppresses ligand desorption. Therefore, the nanoparticle composite of the present invention can, for example, contain silica particles and other particles as the functional particles, thereby weather resistance is improved by silica particles while other functions are provided by the other particles.

TABLE 1

| | functional particle | | | | | weather resistance | |
|---|---|---|---|---|---|---|---|
| | | | BET | | | rate of change | ΔTG |
| | | | diameter | ligand | nanoparticle | in QY after | peak temperature |
| | Oxide | morphology | (nm) | type | structure | 100 hours | of the valley |
| Experiment 1 | SiO₂ | sol | 5 | MPA | CdSe/ZnSe/ZnS | 6.8 | 400 °C |
| Experiment 2 | SiO₂ | sol | 12 | MPA | CdSe/ZnSe/ZnS | 6.3 | 390 °C |
| Experiment 3 | SiO₂ | sol | 22 | MPA | CdSe/ZnSe/ZnS | 8.9 | 420 °C |
| Experiment 4 | SiO₂ | sol | 45 | MPA | CdSe/ZnSe/ZnS | 13.1 | 400 °C |
| Experiment 5 | SiO₂ | fumed | 7 | MPA | CdSe/ZnSe/ZnS | 15.6 | 300 °C |
| Experiment 6 | SiO₂ | fumed | 12 | MPA | CdSe/ZnSe/ZnS | 18.9 | 310 °C |
| Experiment 7 | SiO₂ | fumed | 20 | MPA | CdSe/ZnSe/ZnS | 8 | 330 °C |
| Experiment 8 | SiO₂ | fumed | 45 | MPA | CdSe/ZnSe/ZnS | 21.4 | 300 °C |
| Experiment 9 | — | — | — | MPA | CdSe/ZnSe/ZnS | 100 | 220 °C |
| Experiment 10 | ZrO₂ | sol | 15 | MPA | CdSe/ZnSe/ZnS | 16.9 | 400 °C |
| Experiment 11 | Al₂O₃ | sol | 30 | MPA | CdSe/ZnSe/ZnS | 22.8 | 370 °C |
| Experiment 12 | TiO₂ | sol | 20 | MPA | CdSe/ZnSe/ZnS | 30.6 | 380 °C |
| Experiment 13 | Al₂O₃ | fumed | 13 | MPA | CdSe/ZnSe/ZnS | 98.0 | 250 °C |
| Experiment 14 | TiO₂ | fumed | 20 | MPA | CdSe/ZnSe/ZnS | 83.0 | 260 °C |
| Experiment 15 | Mg(OH)₂ | — | 70 | MPA | CdSe/ZnSe/ZnS | 99.8 | 240 °C |
| Experiment 16 | SiO₂ | sol | 12 | MPA | InP/ZnSe/ZnS | 12.6 | 320 °C |

MPA: mercaptopropionic acid

This application includes the following inventions.

Invention (1) described in the present application is a nanoparticle composite comprising a nanoparticle, a ligand bound to said nanoparticle, and functional particles bound to the nanoparticle via said ligand, and having a structure in which said nanoparticle is surrounded by said functional particles.

Invention (2) described in the present application is a nanoparticle composite in which the nanoparticle is contained in an aggregate structure composed of a plurality of functional particles, and said nanoparticle and said aggregate structure are bound via the ligand.

Invention (3) described in the present application is the nanoparticle composite described in invention (1) or (2), wherein said ligand has a nanoparticle binding group that binds to said nanoparticle and a functional particle binding group that binds to said functional particles.

Invention (4) described in the present application is the nanoparticle composite described in invention (3), wherein said ligand is bound to a surface of the nanoparticle via the nanoparticle binding group and also bound to the functional particle via the functional particle binding group.

Invention (5) described in the present application is the nanoparticle composite described in invention (1) or (2), wherein said nanoparticle binding group is monodentate.

Invention (6) as described in the present application is the nanoparticle composite as described in any one of inventions (3) to (5), wherein said nanoparticle binding group is any one selected from the group consisting of thiol groups, amino groups, carboxyl groups, phosphoric acid groups, sulfone groups, imine groups, imide groups, amide groups, and cyanates.

Invention (7) described in the present application is the nanoparticle composite as described in any one of inventions (3) to (6), wherein said nanoparticle binding group is a thiol group or an amino group.

Invention (8) described in the present application is the nanoparticle composite as described in any one of inventions (3) to (7), wherein said functional particle binding group is a carboxyl group or a hydroxyl group.

Invention (9) described in the present application is the nanoparticle composite described in any one of inventions (1) to (8), wherein said ligand includes mercaptopropionic acid or thioglycolic acid.

Invention (10) described in the present application is the nanoparticle composite as described in any one of inventions (1) to (9), wherein said functional particle is a silica particle.

Invention (11) described in the present application is the nanoparticle composite as described in any one of inventions (1) to (9), wherein said functional particle contains a silica particle.

Invention (12) described in the present application is the nanoparticle composite as described in any one of inventions (1) to (11), wherein said nanoparticle is a quantum dot.

Invention (13) described in the present application is the nanoparticle composite as described in any one of inventions (1) to (12), wherein said nanoparticle contains Zn on a surface of the nanoparticle.

Invention (14) described in the present application is the nanoparticle composite of any one of inventions (1) to (13), wherein the nanoparticle is a quantum dot selected from any one of CdSe/ZnSe with a core-shell structure where the core is CdS and the shell is ZnSe; CdSe/ZnSe with a core-shell structure where the core is CdSe and the shell is ZnSe; CdS/ZnSe/ZnS with a core-shell structure where the core is CdS, the first shell is ZnSe and the second shell is ZnS; CdSe/ZnSe/ZnS with a core-shell structure where the core is CdSe, the first shell is ZnSe and the second shell is ZnS; InP/ZnSe with a core-shell structure where the core is InP and the shell is ZnSe; and InP/ZnSe/ZnS with core-shell structure where the core is InP, the first shell is ZnSe and the second shell is ZnS.

Invention (15) described in the present application is the nanoparticle composite of any one of inventions (1) to (14), wherein the nanoparticle is a quantum dot containing Zn on a surface of the nanoparticle, the ligand has a thiol group that can form a Zn—S bond on the surface of the nanoparticle as the nanoparticle binding group, the ligand has a carboxyl or hydroxyl group as the functional particle binding group, and the functional particle is a silica particle with a hydroxyl group.

Invention (16) described in the present application is a dispersion solution containing the nanoparticle composite as described in any one of inventions (1) to (15).

Invention (17) described in the present application is a film containing the nanoparticle composite as described in any one of inventions (1) to (15).

Invention (18) described in the present application is a medical marker using the nanoparticle composite as described in any one of inventions (1) to (15).

Furthermore, the present application includes the following inventions

Invention [1] described in the present application is a method for producing the nanoparticle composite including a step of, in a dispersion solution containing a nanoparticle and a ligand, bonding said nanoparticle and said ligand to obtain a precursor particle dispersion solution, and
a step of mixing and reacting said precursor particle dispersion solution with a dispersion solution containing functional particles to obtain a nanoparticle composite dispersion solution in which said functional particles are bound to said nanoparticle via said ligand.

Invention [2] described in the present application is the method for producing the nanoparticle composite as described in invention [1], wherein said ligand has a nanoparticle binding group that binds to said nanoparticle and a functional particle binding group that binds to said functional particles.

Invention [3] described in the present application is the method for producing the nanoparticle composite as described in invention [2], wherein said functional particle binding group has a carboxyl group or a hydroxyl group.

Invention [4] described in the present application is the method for producing the nanoparticle composite as described in invention [2] or invention [3], wherein said nanoparticle binding group has a thiol group.

Invention [5] described in the present application is the method for producing the nanoparticle composite as described in any one of inventions [1] to [4], wherein the method for producing the nanoparticle composite include, after obtaining the nanoparticle composite dispersion solution, drying the nanoparticle composite dispersion solution.

Invention [6] described in the present application is the method for producing the nanoparticle composite as described in any one of inventions [1] to [5], wherein said precursor particle dispersion solution is aqueous.

Invention [7] described in the present application is the method for producing the nanoparticle composite as described in any one of inventions [1] to [6], wherein said dispersion solution containing the functional particles is aqueous.

Invention [8] described in the present application is the method for producing the nanoparticle composite as described in any one of inventions [1] to [7], wherein said functional particle is a silica particle.

Invention [9] described in the present application is the method for producing the nanoparticle composite as described in any one of inventions [1] to [8], wherein said nanoparticle is a quantum dot.

Invention [10] described in the present application is the method for producing the nanoparticle composite as described in any one of inventions [1] to [9], wherein said nanoparticle contains Zn on a surface of the nanoparticle.

Invention [11] described in the present application is the method for producing the nanoparticle composite as described in any one of inventions [1] to [10], wherein said ligand includes mercaptopropionic acid or thioglycolic acid.

Invention [12] described in the present application is a method for producing the nanoparticle composite as described in any one of inventions [1] to [11], wherein the nanoparticle is a quantum dot containing Zn on a surface of the nanoparticle, the ligand has a thiol group that can form a Zn—S bond on the surface of the nanoparticle as the nanoparticle binding group, the ligand has a carboxyl or hydroxyl group as the functional particle binding group, and the functional particle is a silica particle with a hydroxyl group.

Invention [13] described in the present application is a nanoparticle dispersion solution capable of generating a nanoparticle composite by being mixed and reacted with a dispersion solution containing a functional particle, wherein
said nanoparticle dispersion solution contains nanoparticles and a ligand,
said ligand has a nanoparticle binding group and a functional particle binding group, and
said nanoparticle is dispersed in a state wherein said nanoparticle is bound to said ligand via said nanoparticles binding group.

Invention [14] described in the present application is the nanoparticle dispersion solution as described in invention [13], wherein said functional particle binding group is a carboxyl group or a hydroxyl group.

Invention [15] described in the present application is the nanoparticle dispersion solution as described in invention [14], wherein said nanoparticle dispersion solution is aqueous.

Invention [16] described in the present application is a method for mixing a ligand having a nanoparticle binding group that can bind to a nanoparticle and a functional particle binding group that can bind to functional particles with a nanoparticle to obtain a nanoparticle to which said ligand is bound.

Invention [17] described in the present application is a method for obtaining the nanoparticle as described in invention [16], wherein mixing the nanoparticle to which said ligand is bound and the functional particle is performed.

Invention [18] described in the present application is a method for mixing a ligand having a nanoparticle binding group that can bind to a nanoparticle and a functional particle binding group that can bind to functional particles with a functional particle to obtain a functional particle to which said ligand is bound.

Invention [19] described in the present application is a method for obtaining the functional particle as described in invention [18], wherein mixing the functional particle to which said ligand is bound and the nanoparticle is performed.

Invention [20] described in the present application is a method for producing a nanoparticle composite that include a step of mixing and reacting a dispersion solution containing a functional particle with a dispersion solution containing a nanoparticle to which a ligand is bound.

Invention [20] described in the present application is a method for producing a nanoparticle composite that include a step of mixing and reacting a dispersion solution containing a functional particle, a ligand, and a dispersion solution containing a nanoparticle.

Invention [22] described in the present application is a method for producing a nanoparticle composite that include a step of mixing and reacting a dispersion solution containing a nanoparticle with a dispersion solution containing a functional particle to which a ligand is bound.

Invention [23] described in the present application is a method for producing a nanoparticle composite dispersion, wherein a nanoparticle to which a ligand is bound and a functional particle are reacted nanoparticle composite dispersion in which said functional particle is bound to said nanoparticle via said ligand.

Invention [24] described in the present application is a method for producing a nanoparticle composite dispersion, wherein a functional particle to which a ligand is bound and a nanoparticle are reacted to obtain a nanoparticle composite in which said functional particle is bound to said nanoparticle via said ligand.

Invention [25] described in the present application is a method for producing a nanoparticle composite dispersion, wherein a nanoparticle, a ligand, and a functional particle are reacted to obtain a nanoparticle composite dispersion in which said functional particle is bound to said nanoparticle via said ligand.

### REFERENCE CHARACTER LIST

| | |
|---|---|
| 11 | Nanoparticle |
| 12 | Ligand |
| 13 | Functional particle |
| 14 | Aggregated structure |

1. A nanoparticle composite comprising a nanoparticle, a ligand bound to the nanoparticle, and a functional particle bound to the nanoparticle via the ligand, and having a structure in which the nanoparticle is surrounded by the functional particle.

2. (canceled)

3. The nanoparticle composite according to claim 1, wherein the ligand has a nanoparticle binding group that binds to the nanoparticle and a functional particle binding group that binds to the functional particles.

4. The nanoparticle composite according to claim 3, wherein the ligand is bound to a surface of the nanoparticle via the nanoparticle binding group and also bound to the functional particle via the functional particle binding group.

5. The nanoparticle composite according to claim 3, wherein the nanoparticle binding group is monodentate.

6. The nanoparticle composite according to claim 3, wherein the nanoparticle binding group is any one selected from the group consisting of thiol groups, amino groups, carboxyl groups, phosphoric acid groups, sulfone groups, imine groups, imide groups, amide groups, and cyanates.

7. (canceled)

8. The nanoparticle composite according to claim 3, wherein the functional particle binding group is a carboxyl group or a hydroxyl group.

9-10. (canceled)

11. The nanoparticle composite according to claim 1, wherein the functional particle contains a silica particle.

12. The nanoparticle composite according to claim 1, wherein the nanoparticle is a quantum dot.

13-15. (canceled)

16. A dispersion solution containing the nanoparticle composite according to claim 1.

17. A film containing the nanoparticle composite according to claim 1.

18. (canceled)

19. A nanoparticle composite in which a nanoparticle is contained in an aggregate structure composed of a plurality of functional particles, and the nanoparticle and the aggregate structure are bound via a ligand.

20. The nanoparticle composite according to claim 19, wherein the ligand has a nanoparticle binding group that binds to the nanoparticle and a functional particle binding group that binds to the functional particles.

21. The nanoparticle composite according to claim 20, wherein the ligand is bound to a surface of the nanoparticle via the nanoparticle binding group and also bound to the functional particle via the functional particle binding group.

22. The nanoparticle composite according to claim 20, wherein the nanoparticle binding group is monodentate.

23. The nanoparticle composite according to claim 20, wherein the nanoparticle binding group is any one selected from the group consisting of thiol groups, amino groups, carboxyl groups, phosphoric acid groups, sulfone groups, imine groups, imide groups, amide groups, and cyanates.

24. The nanoparticle composite according to claim 20, wherein the functional particle binding group is a carboxyl group or a hydroxyl group.

25. The nanoparticle composite according to claim 19, wherein the functional particle contains a silica particle.

26. The nanoparticle composite according to claim 19, wherein the nanoparticle is a quantum dot.

27. A dispersion solution containing the nanoparticle composite according to claim 19.

28. A film containing the nanoparticle composite according to claim 19.
